(19) United States
(12) Patent Application Publication
(10) Pub. No.: US 2024/0389211 A1
(43) Pub. Date: Nov. 21, 2024

(54) EMERGENCY ILLUMINATION CIRCUIT

(71) Applicant: Xiamen Topstar Lighting Co., Ltd., Xiamen (CN)

(72) Inventors: Yongjie WU, Xiamen (CN); Naijun YANG, Xiamen (CN)

(73) Assignee: Xiamen Topstar Lighting Co., Ltd., Xiamen (CN)

(21) Appl. No.: 18/790,062

(22) Filed: Jul. 31, 2024

(30) Foreign Application Priority Data
Jul. 12, 2024 (CN) 202421649594.4

(51) Int. Cl. H05B 47/17; H05B 45/20; H05B 45/3725; H05B 47/155

(52) U.S. Cl. CPC H05B 47/172; H05B 45/20; H05B 45/3725; H05B 47/155

(57) ABSTRACT

Disclosed is an emergency illumination circuit, including an LED driving module, an emergency light source, a main illumination light source, a switch module and an emergency illumination detection module. An input end of the LED driving module and a detection end of the emergency illumination detection module are both used for being connected to a power source; an output end of the LED driving module is connected to an input end of the switch module; the main illumination light source includes a low color temperature light source and a high color temperature light source; and an output end of the emergency illumination detection module is connected to the emergency light source. The multi-color temperature illumination and emergency flashlight functions are realized by a switch module. when the emergency illumination detection module detects that the mains electricity switch is turned off, the emergency light source is started.

### CROSS-REFERENCE TO RELATED APPLICATIONS

This application claims priority to Chinese Patent Application No. 202421649594.4, filed on Jul. 12, 2024, the content of which is incorporated herein by reference in its entirety.

### TECHNICAL FIELD

The present application relates to the technical field of emergency illumination, and in particular to an emergency illumination circuit.

### BACKGROUND

At present, the traditional flashlight mode of emergency illumination line is realized through rectifier bridge front access switch and resistor. In order to achieve multi-color temperature illumination, a further set of switches for switching the color temperature needs to be provided. Therefore, conventionally designed lines typically require two sets of switches to implement the emergency illumination function as well as the color temperature switching function. Since two sets of switches are required, and one set of switches is located in front of the bridge, and one set of switches is located behind the bridge, the product design will be affected by the size of structural space, etc. and it is difficult to realize the emergency flashlight function.

### SUMMARY

The technical problem to be solved by the present application is: an emergency illumination circuit is provided to solve the problems of multi-color temperature illumination and emergency flashlight function through two sets of switches.

In order to solve the above-mentioned technical problem, the technical solution adopted by the present application is: an emergency illumination circuit including an LED driving module, an emergency light source, a main illumination light source, a switch module and an emergency illumination detection module; where an input end of the LED driving module and a detection end of the emergency illumination detection module are both used for being connected to a power source; an output end of the LED driving module is connected to an input end of the switch module; the output end of the switch module is gatedly connected to the main illumination light source or the emergency illumination detection module; the main illumination light source includes a low color temperature light source and a high color temperature light source, and the switch module includes at least two color temperature gears for gating the low color temperature light source or the high color temperature light source; and an output end of the emergency illumination detection module is connected to the emergency light source.

Further, the switch module further includes a third gear connected to the low color temperature light source and the high color temperature light source.

Further, the switch module includes a gating switch, a first path, a second path, a third path, a fourth path, a fifth path, a first current-limiting resistor and a second current-limiting resistor; a fixed end of the gating switch is connected to the output end of the LED driving module; a gating end of the gating switch is gatedly connected to an input end of the first path, an input end of the second path, an input end of the third path, an input end of the fourth path or an input end of the fifth path; an output end of the first path is connected to the low color temperature light source; the second path includes a first branch and a second branch; an output end of the first branch is connected to the low color temperature light source, an output end of the second branch is connected to the first current-limiting resistor, and the other end of the first current-limiting resistor is connected to the high color temperature light source; the third path includes a third branch and a fourth branch; an output end of the third branch is connected to the low color temperature light source, and an output end of the fourth branch is connected to the high color temperature light source; the fourth path includes a fifth branch and a sixth branch; the output end of the fifth branch is connected to the second current-limiting resistor, the other end of the second current-limiting resistor is connected to the low color temperature light source, and the output end of the sixth branch is connected to the high color temperature light source; and an output end of the fifth path is connected to the high color temperature light source.

Further, the input end of the second path, the input end of the third path, and the input end of the fourth path are each provided with a diode, and are positively connected to the diode.

Further, the switch module further includes an emergency path; an input end of the emergency path is connected to a gating end of the gating switch; and an output end of the emergency path is connected to a detection end of the emergency illumination detection module.

Further, the emergency illumination detection module includes an emergency detection chip and an emergency power source; the detection end of the emergency detection chip is used for being connected to the mains electricity; a power source input end of the emergency detection chip is respectively connected to the emergency power source and a negative electrode of the main illumination light source; and an enable of the emergency detection chip is connected to the emergency light source.

Further, the LED driving module includes a rectifier bridge, a filtering unit and a driving chip; an input end of the rectifier bridge is used for being connected to the mains electricity; an output end of the rectifier bridge is connected to an input end of the filtering unit; and the output ends of the filtering unit are respectively connected to the power supply end of the driving chip and the input end of the switch module.

Further, the filtering unit includes a first inductor, a first capacitor, a first resistor and an electrolytic capacitor; one end of the first inductor is respectively connected to one end of the first capacitor, one end of the first resistor and an output end of the rectifier bridge; the other end of the first inductor is respectively connected to one end of the electrolytic capacitor, the other end of the first resistor, a power supply end of the driving chip and an input end of the switch module; and the other end of the first capacitor is connected to the other end of the electrolytic capacitor, and is grounded.

The beneficial effects of the present application are: by providing a switch module at an output end of the LED driving module, and the switch module being used for gating a main illumination light source or an emergency illumination detection module, and the main illumination light source including a low color temperature light source and a high color temperature light source, and being able to perform color temperature switching via at least two color temperature gears of the switch module, i.e., achieving multi-color temperature illumination and an emergency flashlight function via one switch module; at the same time, a switch closed state between the mains electricity neutral line and the live wire can be detected by the emergency illumination detection module, and when it is detected that the switch is open, the emergency light source is activated to realize the emergency flashlight mode.

### BRIEF DESCRIPTION OF THE DRAWINGS

FIG. 1 is a circuit diagram of an emergency illumination circuit according to an embodiment of the present application.

FIG. 2 is a circuit diagram of a switch module in an emergency illumination circuit according to an embodiment of the present application.

FIG. 3 is a circuit diagram of an emergency illumination detection module in an emergency illumination circuit according to an embodiment of the present application.

FIG. 4 is a circuit diagram of an LED driving module in an emergency illumination circuit according to an embodiment of the present application.

FIG. 5 is a schematic diagram of an emergency mode loop in an emergency illumination circuit according to an embodiment of the present application.

### DETAILED DESCRIPTION OF THE EMBODIMENTS

In order to explain the technical contents, the objects, and the effects of the present application in detail, the embodiments will be described below referring to the accompanying drawings.

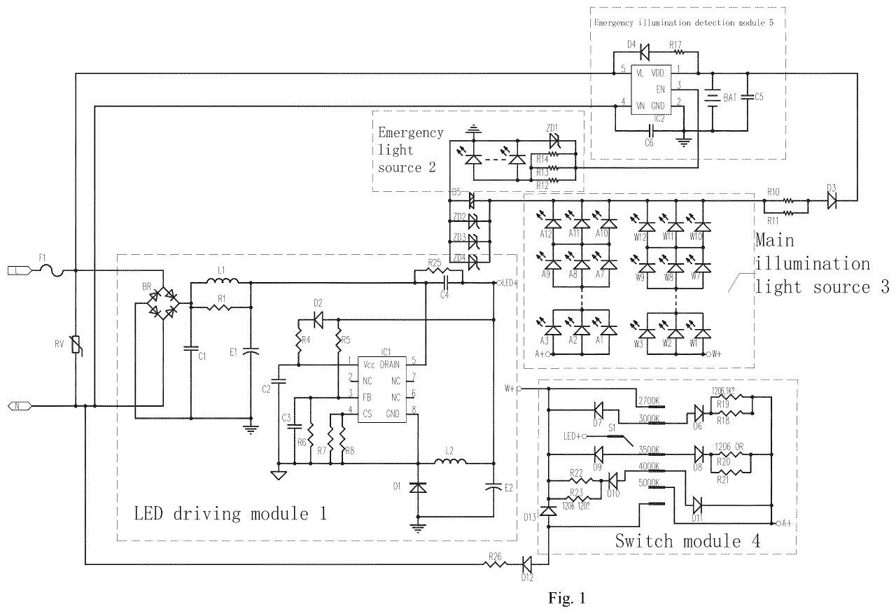

Referring to FIG. 1, an emergency illumination circuit is provided, which includes an LED driving module, an emergency light source, a main illumination light source, a switch module and an emergency illumination detection module; where an input end of the LED driving module and a detection end of the emergency illumination detection module are both used for being connected to a power source; an output end of the LED driving module is connected to an input end of the switch module; the output end of the switch module is gatedly connected to the main illumination light source or the emergency illumination detection module; the main illumination light source includes a low color temperature light source and a high color temperature light source, and the switch module includes at least two color temperature gears for gating the low color temperature light source or the high color temperature light source; and an output end of the emergency illumination detection module is connected to the emergency light source.

It can be seen from the above description that the beneficial effects of the present application are: by providing a switch module at an output end of the LED driving module, and the switch module being used for gating a main illumination light source or an emergency illumination detection module, and the main illumination light source including a low color temperature light source and a high color temperature light source, and being able to perform color temperature switching via at least two color temperature gears of the switch module, i.e., achieving multi-color temperature illumination and an emergency flashlight function via one switch module; at the same time, a switch closed state between the mains electricity neutral line and the live wire can be detected by the emergency illumination detection module, and when it is detected that the switch is open, the emergency light source is activated to realize the emergency flashlight mode.

Further, the switch module further includes a third gear connected to the low color temperature light source and the high color temperature light source.

It can be seen from the above-mentioned description that the adjustment of the intermediate color temperature is achieved by setting the third gear to be in simultaneous communication with the low color temperature light source and the high color temperature light source.

Further, the switch module includes a gating switch, a first path, a second path, a third path, a fourth path, a fifth path, a first current-limiting resistor and a second current-limiting resistor; a fixed end of the gating switch is connected to the output end of the LED driving module; a gating end of the gating switch is gatedly connected to an input end of the first path, an input end of the second path, an input end of the third path, an input end of the fourth path or an input end of the fifth path; an output end of the first path is connected to the low color temperature light source; the second path includes a first branch and a second branch; an output end of the first branch is connected to the low color temperature light source, an output end of the second branch is connected to the first current-limiting resistor, and the other end of the first current-limiting resistor is connected to the high color temperature light source; the third path includes a third branch and a fourth branch; an output end of the third branch is connected to the low color temperature light source, and an output end of the fourth branch is connected to the high color temperature light source; the fourth path includes a fifth branch and a sixth branch; the output end of the fifth branch is connected to the second current-limiting resistor, the other end of the second current-limiting resistor is connected to the low color temperature light source, and the output end of the sixth branch is connected to the high color temperature light source; and an output end of the fifth path is connected to the high color temperature light source.

It can be seen from the above-mentioned description that by providing five paths, different color temperature modes can be realized respectively through the five paths so as to satisfy the user's setting requirements for different color temperatures.

Further, the input end of the second path, the input end of the third path, and the input end of the fourth path are each provided with a diode, and are positively connected to the diode.

It can be seen from the above description that the stability of the channel current is improved by providing a diode connected in a forward direction at the input end of the second channel, the input end of the third channel and the input end of the fourth channel.

Further, the switch module further includes an emergency path; an input end of the emergency path is connected to a gating end of the gating switch; and an output end of the emergency path is connected to a detection end of the emergency illumination detection module.

It can be seen from the above-mentioned description that by providing an emergency path, when the switch module dials to the emergency path, the emergency illumination detection module is connected to realize that the user actively enables the emergency illumination function.

Further, the emergency illumination detection module includes an emergency detection chip and an emergency power source; the detection end of the emergency detection chip is used for being connected to the mains electricity; a power source input end of the emergency detection chip is respectively connected to the emergency power source and a negative electrode of the main illumination light source; and an enable of the emergency detection chip is connected to the emergency light source.

It can be seen from the above-mentioned description that an emergency illumination detection module is composed of an emergency detection chip and an emergency power source, and a power source input end of the emergency detection chip is respectively connected to an emergency power source and a negative electrode of a main illumination light source, so that the main illumination light source can also charge the emergency power source when working, and the emergency power source can be ensured to be a stable power source of the emergency detection chip.

Further, the LED driving module includes a rectifier bridge, a filtering unit and a driving chip; an input end of the rectifier bridge is used for being connected to the mains electricity; an output end of the rectifier bridge is connected to an input end of the filtering unit; and the output ends of the filtering unit are respectively connected to the power supply end of the driving chip and the input end of the switch module.

It can be seen from the above-mentioned description that the input mains electricity is converted into a direct current by providing a rectifier bridge, and then the input power source is filtered by a filtering unit so as to provide a stable direct current for the driving chip and the main illumination light source.

Further, the filtering unit includes a first inductor, a first capacitor, a first resistor and an electrolytic capacitor; one end of the first inductor is respectively connected to one end of the first capacitor, one end of the first resistor and an output end of the rectifier bridge; the other end of the first inductor is respectively connected to one end of the electrolytic capacitor, the other end of the first resistor, a power supply end of the driving chip and an input end of the switch module; and the other end of the first capacitor is connected to the other end of the electrolytic capacitor, and is grounded.

It can be seen from the above-mentioned description that the first inductor, the first capacitor, the first resistor and the electrolytic capacitor constitute x-shaped filtering, so that the alternating current component in the power source can be effectively filtered out.

The products provided in the present application, such as an emergency illumination circuit, an emergency battery lamp, etc. achieve common illumination with multiple color temperature functions, and an emergency flashlight function, are described below by way of specific embodiments:

Referring to FIG. 1, an emergency illumination circuit includes an LED driving module 1, an emergency light source 2, a main illumination light source 3, a switch module 4 and an emergency illumination detection module 5; an input end of the LED driving module 1 and a detection end of the emergency illumination detection module 5 are both used for being connected to a power source; an output end (LED+) of the LED driving module 1 is connected to an input end of the switch module 4; an output end of the switch module 4 is gatedly connected to the main illumination light source 3 or the emergency illumination detection module 5; the main illumination light source 3 includes a low color temperature light source and a high color temperature light source, and the switch module 4 includes at least two color temperature gears for gating the low color temperature light source or the high color temperature light source; an output end of the emergency illumination detection module 5 is connected to the emergency light source 2; where the switch module 4 further includes a third gear, and the third gear is connected to the low color temperature light source and the high color temperature light source.

Referring to FIG. 2, the switch module 4 includes a gating switch S1, a first path, a second path, a third path, a fourth path, a fifth path, a first current-limiting resistor R18 and a second current-limiting resistor R22; a fixed end of the gating switch S1 is connected to an output end (LED+) of the LED driving module 1; a gating end of the gating switch S1 is gatedly connected to an input end of a first path, an input end of a second path, an input end of a third path, an input end of a fourth path or an input end of a fifth path; where the proportion of the current-limiting resistors accessed by the two light sources is different under different gears, and therefore the proportion of the currents of the two light sources is different so as to realize different proportions of the color temperature, and the specific color temperature can be adjusted according to the resistance value, and the specific arrangement mode of each path is as follows.

An output end of the first path is connected to a low color temperature light source (W+); at this time, the LED driving module 1 communicates with a low color temperature light source, and the color temperature is 2700 K.

The second path includes a first branch and a second branch; the output end of the first branch is connected to a low color temperature light source (W+), the output end of the second branch is connected to a first current-limiting resistor R18, and the other end of the first current-limiting resistor R18 is connected to a high color temperature light source (A+); the first current-limiting resistor R18 can also be realized by two resistors in parallel, and is composed of a resistor R18 and a resistor R19 as shown in FIG. 2. At this time, the LED driving module 1 is in communication with a low color temperature light source and a high color temperature light source at the same time, and the high color temperature light source branch is provided with a current-limiting resistor, and the color temperature is 3000 K.

The third path includes a third branch and a fourth branch; an output end of the third branch is connected to a low color temperature light source, and an output end of the fourth branch is connected to a high color temperature light source; at this time, the LED driving module 1 is in communication with a low color temperature light source and a high color temperature light source at the same time, and the color temperature is 3500 K; the high color temperature branch is also provided with a 0Ω resistor, which can be used as a jumper.

The fourth path includes a fifth branch and a sixth branch; the output end of the fifth branch is connected to the second current-limiting resistor R22, the other end of the second current-limiting resistor R22 is connected to the low color temperature light source, and the output end of the sixth branch is connected to the high color temperature light source; at this time, the LED driving module 1 is in communication with a low color temperature light source and a high color temperature light source at the same time, and the low color temperature light source branch is provided with a current-limiting resistor, and the color temperature is 4000 K.

An output end of the fifth path is connected to a high color temperature light source; at this time, the LED driving module 1 communicates with a high color temperature light source, and the color temperature is 5000 K.

The switch module 4 further includes an emergency path; an input end of the emergency path is connected to a gating end of the gating switch S1; an output end of the emergency path is connected to a detection end of the emergency illumination detection module 5; as shown in FIG. 1, the emergency path is further provided with a resistor R26 and a diode D12, so that the emergency path is in communication with the neutral line; that is, a diode is added after the rectifier bridge BR, and a loop connecting the resistance connection line to the neutral line is designed to realize the emergency illumination function of the flashlight.

At the same time, the output end of the emergency path, the input end of the second path, the input end of the third path and the input end of the fourth path are all provided with a diode, and are connected to the diode in a forward direction; as shown in FIG. 2, diodes D6-D12 are included.

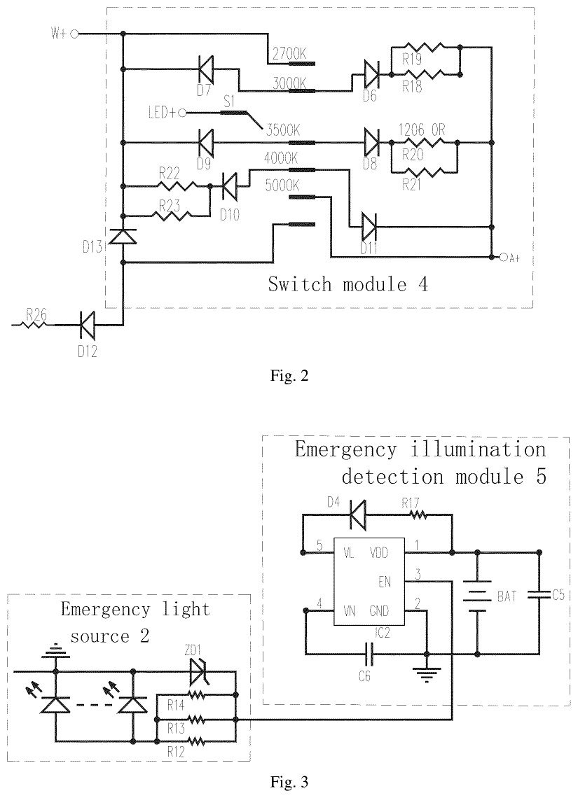

Referring to FIG. 3, the emergency illumination detection module 5 includes an emergency detection chip IC2 and an emergency power source BAT; the detection end (VL & VN) of the emergency detection chip IC2 is used for being connected to the mains electricity; a power source input end (VDD) of the emergency detection chip IC2 is respectively connected to the emergency power source BAT and a negative electrode of the main illumination light source 3; after passing through the negative electrode of the main illumination light source 3, the current also needs to flow through a resistor and a diode before reaching the power source input end of the emergency detection chip IC2; and an enable (EN) of the emergency detection chip IC2 is connected to the emergency light source 2.

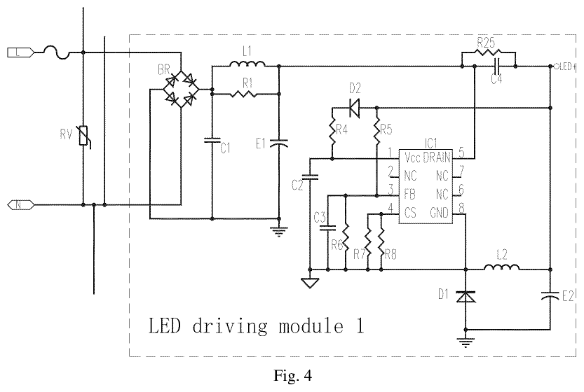

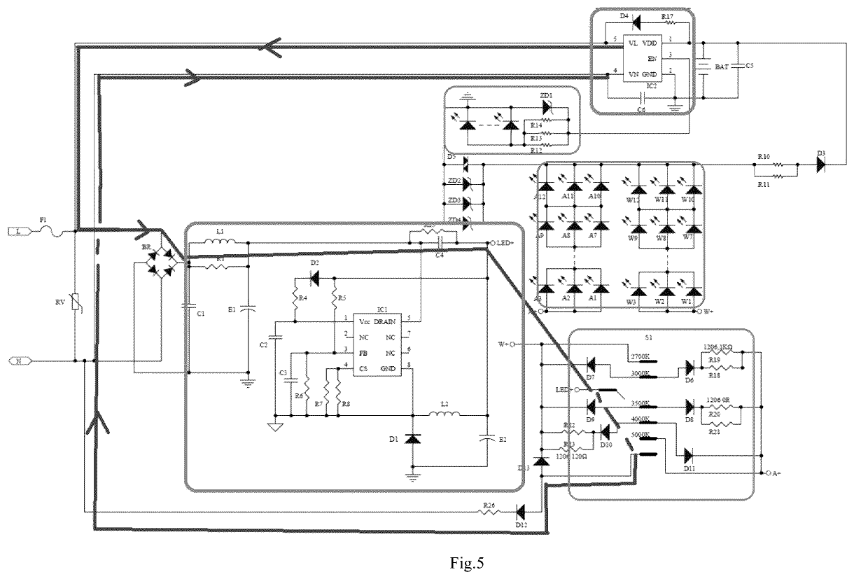

Referring to FIG. 4, the LED driving module 1 includes a rectifier bridge BR, a filtering unit and a driving chip IC1; the input end of the rectifier bridge BR is used for being connected to the mains electricity; an output end of the rectifier bridge BR is connected to an input end of the filtering unit; and the output ends of the filtering unit are respectively connected to a power supply end of the driving chip IC1 and an input end of the switch module 4; where the filtering unit includes a first inductor L1, a first capacitor C1, a first resistor R1 and an electrolytic capacitor E1; one end of the first inductor L1 is respectively connected to one end of the first capacitor C1, one end of the first resistor R1 and an output end of the rectifier bridge BR; the other end of the first inductor L1 is respectively connected to one end of the electrolytic capacitor E1, the other end of the first resistor R1, a power supply end of the driving chip IC1 and an input end of the switch module 4; the other end of the first capacitor C1 is connected to the other end of the electrolytic capacitor E1, and is grounded.

The specific working principle of the above emergency illumination circuit is as follows.

When the mains electricity power source (L & N) is connected, the LED driving module 1 provides voltage and current for the main illumination light source 3 module, drives the main illumination light source 3 to work normally, and provides charging for the emergency power source BAT at the same time; when the emergency power source BAT is fully charged, the main illumination loop forms a working circuit through the voltage regulator tube to ground.

When the switches of the switch module 4 are dialed into different gears, a color temperature change is achieved. At this time, the emergency illumination detection module 5 receives the LN signal, the internal switch tube thereof is off, and the enable outputs a low level, and therefore the emergency light source 2 does not form a working loop and does not work.

When the mains electricity is off (the lamp is still connected to the lamp holder LN), since a certain impedance exists between the live wire and the neutral wire (a certain impedance exists in the power grid transformer), the emergency detection chip IC2 detects a cut-off signal, and the enable outputs a high level, so that a current loop is formed between the emergency power source BAT and the emergency light source 2, and the emergency illumination works at this time. When the lamp is plugged into the mains electricity, after the mains electricity is off, the lamp can be automatically lit in emergency without the need for toggling the switch.

Referring to FIG. 5, when the product is removed from the lamp holder (naturally disconnected from the mains electricity), the switch is toggled to the emergency gear; at this time, the emergency detection chip IC2 detects a loop signal, and the enable outputs a high level, so that a current loop is formed between the emergency power source BAT and the emergency light source 2, and the emergency flashlight mode is achieved. After the lamp is removed from the lamp holder, if an emergency is required, the switch needs to be toggled to activate emergency illumination.

The above-mentioned embodiments are merely examples of the present application and do not limit the scope of the patent of the present application. Any equivalent change made by using the contents of the description and the drawings of the present application or directly or indirectly used in relevant technical fields is likewise included in the scope of the patent protection of the present application.

What is claimed is:

1. An emergency illumination circuit, comprising a light-emitting diode (LED) driving module, an emergency light source, a main illumination light source, a switch module and an emergency illumination detection module; wherein
an input end of the LED driving module and a detection end of the emergency illumination detection module are both used for being connected to a power source;
an output end of the LED driving module is connected to an input end of the switch module;
an output end of the switch module is gatedly connected to the main illumination light source or the emergency illumination detection module;
the main illumination light source comprises a low color temperature light source and a high color temperature light source, and the switch module comprises at least two color temperature gears for gating the low color temperature light source or the high color temperature light source; and
an output end of the emergency illumination detection module is connected to the emergency light source.

2. The emergency illumination circuit according to claim 1, wherein the switch module further comprises a third gear connected to the low color temperature light source and the high color temperature light source.

3. The emergency illumination circuit according to claim 2, wherein the switch module comprises a gating switch, a first path, a second path, a third path, a fourth path, a fifth path, a first current-limiting resistor and a second current-limiting resistor;
a fixed end of the gating switch is connected to the output end of the LED driving module;
a gating end of the gating switch is gatedly connected to an input end of the first path, an input end of the second path, an input end of the third path, an input end of the fourth path or an input end of the fifth path;
an output end of the first path is connected to the low color temperature light source;
the second path comprises a first branch and a second branch; an output end of the first branch is connected to the low color temperature light source, an output end of the second branch is connected to the first current-limiting resistor, and the other end of the first current-limiting resistor is connected to the high color temperature light source;
the third path comprises a third branch and a fourth branch; an output end of the third branch is connected to the low color temperature light source, and an output end of the fourth branch is connected to the high color temperature light source;
the fourth path comprises a fifth branch and a sixth branch; the output end of the fifth branch is connected to the second current-limiting resistor, the other end of the second current-limiting resistor is connected to the low color temperature light source, and the output end of the sixth branch is connected to the high color temperature light source; and
an output end of the fifth path is connected to the high color temperature light source.

4. The emergency illumination circuit according to claim 3, wherein the input end of the second path, the input end of the third path, and the input end of the fourth path are each provided with a diode, and are positively connected to the diode.

5. The emergency illumination circuit according to claim 3, wherein the switch module further comprises an emergency path;
an input end of the emergency path is connected to a gating end of the gating switch; and
an output end of the emergency path is connected to a detection end of the emergency illumination detection module.

6. The emergency illumination circuit according to claim 1, wherein the emergency illumination detection module comprises an emergency detection chip and an emergency power source;
the detection end of the emergency detection chip is used for being connected to the mains electricity;
a power source input end of the emergency detection chip is respectively connected to the emergency power source and a negative electrode of the main illumination light source; and
an enable of the emergency detection chip is connected to the emergency light source.

7. The emergency illumination circuit according to claim 1, wherein the LED driving module comprises a rectifier bridge, a filtering unit and a driving chip;
an input end of the rectifier bridge is used for being connected to the mains electricity;
an output end of the rectifier bridge is connected to an input end of the filtering unit; and
the output ends of the filtering unit are respectively connected to the power supply end of the driving chip and the input end of the switch module.

8. The emergency illumination circuit according to claim 7, wherein the filtering unit comprises a first inductor, a first capacitor, a first resistor and an electrolytic capacitor,
one end of the first inductor is respectively connected to one end of the first capacitor, one end of the first resistor and an output end of the rectifier bridge;
the other end of the first inductor is respectively connected to one end of the electrolytic capacitor, the other end of the first resistor, a power supply end of the driving chip and an input end of the switch module; and
the other end of the first capacitor is connected to the other end of the electrolytic capacitor, and is grounded.
